(19) United States
(12) Patent Application Publication
(10) Pub. No.: US 2023/0259641 A1
(43) Pub. Date: Aug. 17, 2023

(54) DEVICE, METHOD, AND SYSTEM FOR ENCRYPTION DATABASE

(71) Applicant: ELECTRONICS AND TELECOMMUNICATIONS RESEARCH INSTITUTE, Daejeon (KR)

(72) Inventors: Seung Kwang LEE, Daejeon (KR); Nam Su JHO, Daejeon (KR)

(73) Assignee: ELECTRONICS AND TELECOMMUNICATIONS RESEARCH INSTITUTE, Daejeon (KR)

(21) Appl. No.: 18/151,244

(22) Filed: Jan. 6, 2023

(30) Foreign Application Priority Data
Feb. 17, 2022 (KR) 10-2022-0020799

(51) Int. Cl. G06F 21/60; G06F 21/78; G06F 21/62

(52) U.S. Cl. CPC G06F 21/602; G06F 21/78; G06F 21/6218

(57) ABSTRACT

Disclosed are an encryption database device, method, and system. The encryption database device includes a memory configured to store and read information, and a processor configured to control the storing and reading of the memory, wherein the processor is configured to allocate blocks to the memory and store at least one ciphertext for plaintext for each of the blocks, generate mapping information associating order information of the plaintext with block information obtained by encrypting a start position of the block in which the ciphertext is stored, access the block associated with the order information corresponding to a search range of the plaintext requested by a client using the mapping information, and respond with information related to the ciphertext of the accessed block to the client.

### CROSS-REFERENCE TO RELATED APPLICATION

This application claims priority to and the benefit of Korean Patent Application No. 10-2022-0020799, filed on Feb. 17, 2022, the disclosure of which is incorporated herein by reference in its entirety.

### BACKGROUND

### 1. Field of the Invention

The present disclosure relates to an encryption database device, method, and system, and more particularly, to an encryption database device, method, and system that satisfy both efficiency and security of search and information change.

### 2. Discussion of Related Art

In order to prevent leakage of information that may occur from a database (DB) entrusted to a third party, data may be stored after being encrypted. Unlike an unencrypted DB, in order to select information corresponding to a query range when a corresponding data field is encrypted, a device having a DB is required to access all rows stored in the DB. Due to repetitive decryption operations that need to be performed in this process, the performance of the DB is degraded. Therefore, in the field of encryption DB, a reduction in efficiency of a range search operation is a persistent problem.

In addition, a deterministic calculation method in which a given plaintext is always calculated as the same ciphertext may analyze the plaintext corresponding to encrypted data by comparing the distribution of ciphertext stored in an encryption DB with the distribution of known plaintext.

The conventional order-preserving encryption or an encryption DB to which order-preserving encryption is applied has the following limitations. First, when a plaintext is encrypted and stored in a DB using a hypergeometric distribution-based ciphertext sampling method, an approximate value of the plaintext may be estimated from the ciphertext, and distance information between plaintexts may be inferred from two ciphertexts. Second, in this case, when encryption is performed by a deterministic algorithm, the distribution of ciphertext is the same as the distribution of plaintext. Third, when an encryption DB is constructed by tree-based order-preserving encryption, some or all of the ciphertexts stored in the DB has the disadvantage of having to be updated due to tree rotation.

### SUMMARY OF THE INVENTION

The present invention is directed to an encryption database device, method, and system that satisfy both efficiency and security of search and information change.

The technical problems to be achieved in the present disclosure are not limited to the technical problems mentioned above, and unmentioned other problems may be clearly understood by those skilled in the art from the following description.

According to an aspect of the present invention, there is provided an encryption database device including a memory configured to store and read information; and a processor configured to control the storing and reading of the memory. The processor may be configured to allocate blocks to the memory and store at least one ciphertext for plaintext for each of the blocks, generate mapping information associating order information of the plaintext with block information obtained by encrypting a start position of the block in which the ciphertext is stored, access the block associated with the order information corresponding to a search range of the plaintext requested by a client using the mapping information, and respond with information related to the ciphertext of the accessed block to the client.

The order information may be configured according to the order of the size of the plaintext.

When the plaintext is present as a plurality of pieces of identical information, the ciphertext may encrypted by padding a frequency concealment code for each plaintext, and the frequency concealment code may include a different random number or counter information for each plaintext.

The block may store the ciphertext in a number corresponding to a maximum value, and the block information may be generated by encrypting the start position, the maximum value, and the number of ciphertexts stored in the block.

When the block is generated as a plurality of blocks and ciphertexts for different plaintexts are stored as different numbers of blocks, the processor may be configured to allocate different blocks in a number corresponding to the maximum number of blocks, fill a block in which the ciphertext is not stored with dummy data, and form the block information to further include a prefix notifying whether the block is a valid block for storing the ciphertext.

The processor may further receive an insertion request of the ciphertext transmitted from the client, decrypt the block information of the mapping information corresponding to the order information included in the insertion request, allocate, when a block in which the prefix is not present is selected based on the decrypted block information, the ciphertext to the selected block, insert the ciphertext into the allocated block while increasing the number of ciphertexts of the allocated block, add dummy data from a position subsequent to the insertion position of the ciphertext to a position corresponding to a maximum value of the allocated block, and update the mapping information after encrypting the block information of the allocated block.

The processor may further receive an insertion request of the ciphertext transmitted from the client, decrypt the block information of the mapping information corresponding to the order information included in the insertion request, allocate, when a block in which the prefix is present is selected based on the decrypted block information, the ciphertext to the selected block, insert the ciphertext into the allocated block while increasing the number of ciphertexts of the allocated block, and update the mapping information after encrypting the block information of the allocated block.

The processor may further receive an insertion request of the ciphertext transmitted from the client, decrypt the block information of the mapping information corresponding to the order information included in the insertion request, allocate, when it is determined based on the decrypted block information that a block in which the prefix is present stores the ciphertext with the maximum value, the ciphertext to a block subsequent to the block having the maximum value, to insert the ciphertext into the allocated block while increasing the number of ciphertexts of the allocated block, add dummy data from a position subsequent to the insertion position of the ciphertext to a position corresponding to the maximum value of the allocated block, and update the mapping information after encrypting the block information of the allocated block.

The processor may further receive a plaintext deletion request from the client, check the block using the block information of the mapping information corresponding to the order information included in the deletion request, specify a position of an additional conditional sentence related to the plaintext in the checked block, delete ciphertext related to the additional conditional sentence from the specified block, shift the ciphertext at a position subsequent to the deleted position to the deleted position and sequentially store the shifted ciphertext, add dummy data to a position where the ciphertext is destroyed by the shift, and update the mapping information after re-encrypting the block information to update the number of ciphertexts of the specified block.

The processor may further receive an update request of the plaintext from the client, check the block using the block information of the mapping information corresponding to the order information included in the update request, specify a position of an alternative conditional statement related to the plaintext in the checked block, update ciphertext present in the specified block with ciphertext related to the alternative conditional sentence, and update the mapping information after re-encrypting the block information to maintain the number of ciphertexts of the specified block.

According to another aspect of the present invention, there is provided a method of constructing an encryption database using an encryption database device, the method including allocating blocks and storing at least one ciphertext for plaintext for each of the blocks; generating mapping information associating order information of the plaintext with block information obtained by encrypting a start position of the block in which the ciphertext is stored; accessing the block associated with the order information corresponding to a search range of the plaintext requested by a client using the mapping information; and responding with information related to the ciphertext of the accessed block to the client.

According to still another aspect of the present invention, there is provided an encryption database system including an encryption database device including a memory configured to store and read information and a processor configured to control the storing and reading of the memory, and a client including a client agent configured to encrypt and decrypt information exchanged with the device. The processor allocates blocks to the memory and store at least one ciphertext for plaintext for each of the blocks, and generates mapping information associating order information of the plaintext with block information obtained by encrypting a start position of the block in which the ciphertext is stored. The client agent calculates the order information corresponding to a plaintext search range requested by the client, and transmits a query based on the order information to the device. The processor accesses the block associated with the order information corresponding to the plaintext search range requested by the client using the mapping information, extracts the ciphertext of the accessed block, and responds with the extracted ciphertext to the client agent. The client agent decrypts the responded ciphertext and provides the plaintext of the search range to the client.

The features briefly summarized above with respect to the disclosure are merely exemplary aspects of the detailed description of the disclosure that follows, and do not limit the scope of the disclosure.

As described above, according to the present disclosure, it is possible to provide an encryption database device, method, and system that satisfy both the efficiency and security of search and information change.

According to the present disclosure, the efficiency of the search query can be enhanced while the distribution of the plaintext can be concealed. Specifically, plaintext information cannot be inferred from ciphertext stored in an encryption database. In addition, a distance between plaintexts cannot be inferred from a plurality of ciphertexts stored in the encryption database. The distribution and frequency of the plaintext cannot be inferred from the ciphertext stored in the encryption database. In addition, the number of decoding operations required to find a response to a range search can be reduced compared to the related art.

According to the present disclosure, by processing a change in the ciphertext using mapping information between block information and order information generated in a predetermined standard and size, for example, a block mapping table, it is possible to implement the conventional method of updating ciphertext having a large amount of ciphertext change processing in a simpler manner.

Effects obtainable in the present disclosure are not limited to the effects mentioned above, and other effects that are not mentioned may be clearly understood by those skilled in the art from the detailed description below.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a schematic configuration diagram illustrating an encryption database system according to an embodiment of the present disclosure;

FIG. 2 is a schematic block diagram illustrating an encryption database device according to another embodiment of the present disclosure;

FIG. 3 is a flowchart illustrating a method of constructing an encryption database according to another embodiment of the present disclosure;

FIG. 4 is a diagram illustrating a block mapping table;

FIG. 5 is a flowchart illustrating an example of a ciphertext insertion process according to the present disclosure;

FIG. 6 is a diagram illustrating insertion of a ciphertext;

FIG. 7 is a flowchart illustrating another example of a ciphertext insertion process according to the present disclosure;

FIG. 8 is a flowchart illustrating another example of a ciphertext insertion process according to the present disclosure; and

FIG. 9 is a flowchart illustrating a ciphertext deletion process according to the present disclosure.

### DETAILED DESCRIPTION OF EXEMPLARY EMBODIMENTS

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, embodiments that include other components in addition to the components described in the various embodiments are also included in the scope of the present disclosure.

Hereinafter, with reference to the accompanying drawings, embodiments of the present disclosure will be described in detail so that a person skilled in the art can readily carry out the present disclosure. However, the present disclosure may be embodied in many different forms and is not limited to the embodiments described herein.

In the following description of the embodiments of the present disclosure, a detailed description of known functions and configurations incorporated herein will be omitted when it may make the subject matter of the present disclosure rather unclear. Parts not related to the description of the present disclosure in the drawings are omitted, and like parts are denoted by similar reference numerals.

In the present disclosure, when a component is referred to as being “linked,” “coupled,” or “connected” to another component, it is understood that not only a direct connection relationship but also an indirect connection relationship through an intermediate component may also be included. In addition, when a component is referred to as “comprising” or “having” another component, it may mean further inclusion of another component not the exclusion thereof, unless explicitly described to the contrary.

In the present disclosure, the terms first, second, etc. are used only for the purpose of distinguishing one component from another, and do not limit the order or importance of components, etc., unless specifically stated otherwise. Thus, within the scope of this disclosure, a first component in one exemplary embodiment may be referred to as a second component in another embodiment, and similarly a second component in one exemplary embodiment may be referred to as a first component.

In the present disclosure, components that are distinguished from each other are intended to clearly illustrate each feature. However, it does not necessarily mean that the components are separate. That is, a plurality of components may be integrated into one hardware or software unit, or a single component may be distributed into a plurality of hardware or software units. Thus, unless otherwise noted, such integrated or distributed embodiments are also included within the scope of the present disclosure.

In the present disclosure, components described in the various embodiments are not necessarily essential components, and some may be optional components. Accordingly, embodiments consisting of a subset of the components described in one embodiment are also included within the scope of the present disclosure. In addition, exemplary embodiments that include other components in addition to the components described in the various embodiments are also included in the scope of the present disclosure.

Hereinafter, embodiments of the present disclosure will be described with reference to the accompanying drawings.

FIG. 1 is a schematic configuration diagram illustrating an encryption database (DB) system according to an embodiment of the present disclosure.

An encryption database system 10 (hereinafter referred to as a system) may include an encryption DB device 100 and a client 200.

The DB device 100 may be a DB server that exchanges information with the client 200. Hereinafter, the name of reference numeral 100 may be used interchangeably with a DB device or a DB server. The DB device 100 may be a device that communicates and interoperates with another device, for example, a client, and is not limited to the above-described embodiment.

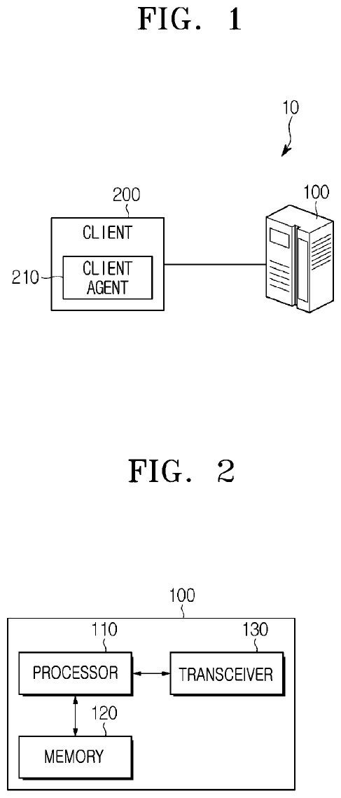

FIG. 2 is a schematic block diagram illustrating an encryption DB device according to another embodiment of the present disclosure. The DB device 100 may include a processor 110, a memory 120, and a transceiver 130 for the above-described operation. The memory 120 may include a storage for storing and reading information requested from the client 200 and function as an encryption database. In this description, the memory 120 may be described interchangeably with an encryption database. The processor 110 may control storing and reading of the memory 120 and process various requests of the client 200. Specifically, the processor 110 may search the encryption database built in the memory 120 in response to a query request of the client 200, extract a ciphertext matching the request, and respond with the ciphertext to the client 200. By an information change request of the client 200, the processor 110 may access the encryption database and perform change processing such as inserting, deleting, or updating ciphertext related to plaintext. The DB device 100 may include components required for communication with other devices, or perform mutual data processing and output the result. The DB device 100 may include other components in addition to the above-described components. That is, the DB device 100 has a configuration including various modules to perform communication with other devices, and is not limited thereto, and may be a device that operates based on the above description.

The client 200 may generate and transmit a user request through a wired/wireless network, or receive result data according to a request from the server 100. The client 200 may include a client agent 210 that encrypts and decrypts information exchanged with the DB device 100. For example, the client agent 210 may encrypt/decrypt a query and a request response based on the request of the client 200 so that the DB device 100 can be utilized.

Detailed functions and operations of the system 10 and the DB device 100 will be described in a method for constructing and changing an encryption database to be described below.

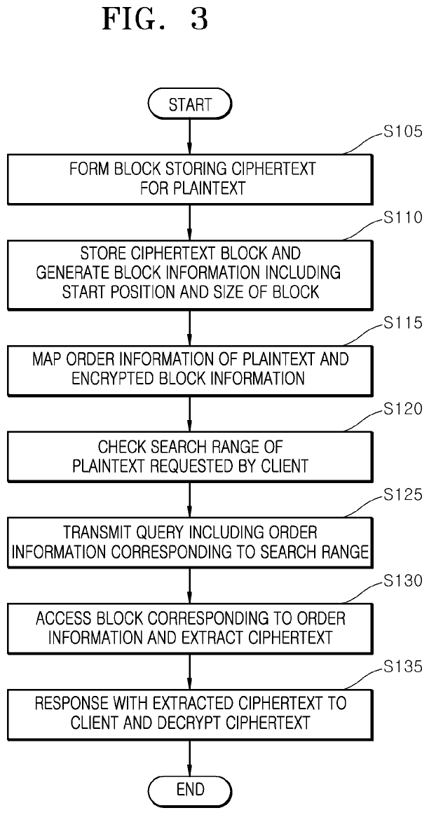

Hereinafter, with reference to FIG. 3, an encryption database construction method according to another embodiment of the present disclosure will be described. FIG. 3 is a flowchart illustrating a method of constructing an encryption database according to another embodiment of the present disclosure.

Prior to the description of the method, terms and notations used in the description may be defined in Table 1.

TABLE 1
Meaning of terms used in this specification

| Notation | Meaning | Notes |
|---|---|---|
| E | Encryption algorithm | Example: Standard |
| | | symmetric key |
| | | encryption (AES) |
| D | Decryption algorithm | |
| Ord | Order information output algorithm | |
| Kc | Encryption secret key of client agent | Example: encryption |
| | | notation E(Kc,) |
| Ko | Order information operation secret | Example: operation |
| | key of client agent | notation Ord(Ko,) |
| Ks | Encryption secret key of server | Example: encryption |
| | | notation E(Ks,) |
| Bₚₓ | Position of block in which ciphertexts | |
| | of plaintext Px are stored | |
| Nₚₓ | Number of ciphertexts stored in | |
| | corresponding block | |

Referring to FIG. 3, in operation S105, the processor 110 may form a block to store at least one ciphertext for plaintext.

The ciphertext may be generated by the client agent 210 based on the plaintext. In order to prevent the frequency of the plaintext from being exposed in the encryption database 120, when the plaintext is present as a plurality of pieces of identical information, the ciphertext may be encrypted by padding a frequency concealment code for each plaintext. The frequency concealment code may include different random numbers or counter information for each plaintext. A plurality of identical plaintexts may be encrypted into different ciphertexts according to the padded frequency concealment code.

To explain the frequency concealment of the plaintext in more detail, in order to conceal the frequency of a plaintext P1 stored in the encryption database 120, the client agent 210 may encrypt P1∥i using the encryption secret key Kc of the client agent 210. This can be written as Cⁱ_{P1}=E(Kc, P1∥i). In this case, ∥ denotes concatenation, and i denotes an arbitrary random number or counter information for P1.

In addition to this, the processor 110 may manage the order information as information associated with the block in the encryption database. The order information may be data utilized in mapping information to be described below. The order information may be generated by, for example, the client agent 210 using the order information operation secret key Ko, and may be configured according to the order of the size of each plaintext.

For example, the order information provided by Ord satisfies Oₚ₁>Oₚ₂ for two given plaintext sizes P1>P2. The order information may be generated as examples described below. As an example, the order information may be calculated by an order-preserving cryptographic algorithm that samples the ciphertext that P1 can take based on the hypergeometric distribution of the total size of plaintext and ciphertext. That is, an encryption result value calculated when P1 is input to the order-preserving encryption based on the hypergeometric distribution may be the order information. As another example, when the entire finite plaintext space is represented as a set {P1, P2, P3, . . . , Pn}, the order information may be given as Oₚ₁=1, Op₃=3. The order information is not limited to the above-described embodiment, and may be calculated in various ways as long as it is generated sequentially according to the size of the plaintext.

Next, in operation S110, the processor 110 may store the ciphertext in the block and generate block information including the start position and size of the block.

The block may store at least one ciphertext, and each ciphertext may be stored at an arbitrarily designated location within the block, for example, at an address allocated to the memory 120. The block may be arbitrarily designated by the processor 110 regardless of the order of the plaintext. Each ciphertext may be, for example, encrypted data for the same plaintext. Each ciphertext may be allocated to addresses of different blocks residing in the memory 120. The block may store the ciphertext in a number corresponding to a maximum value. The maximum value is the maximum value of the number of ciphertexts that can be stored in the corresponding block, and may be expressed as M^{y}ₚₓ in this specification. The maximum value is a factor value that determines the locality of ciphertext stored in the encryption database 120, and may be arbitrarily selected within the range of minimum Mₘᵢₙ and maximum Mₘₐₓ for each block.

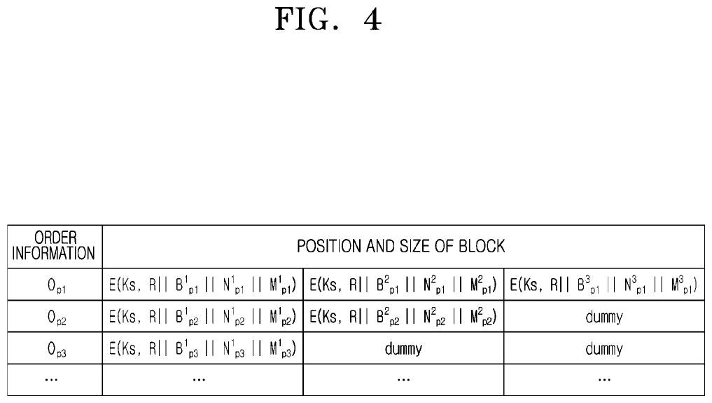

As can be seen through each row of a block mapping table illustrated in FIG. 4, considering a case where a plurality of ciphertexts are allocated up to the storage location of the maximum value in the block, the processor 110 may control the memory 120 to allocate a subsequent block capable of storing ciphertext. FIG. 4 is a diagram illustrating a block mapping table. The processor 110 may generate block information including a start position and size of the block. Information related to the size of the block may include a maximum value and the number of ciphertexts stored in the block. In this specification, the start position of the block may be expressed as B^{y}ₚₓ. B^{y}ₚₓ may specifically be the start address of the block into which a corresponding ciphertext is to be inserted. Here, y is a block index for Px and may correspond to a row index of the block mapping table illustrated in FIG. 4. In this specification, the number of ciphertexts is N^{y}ₚₓ, and N^{y}ₚₓ may be the number of ciphertexts for Px stored in the corresponding block.

In addition, as shown in FIG. 4, the processor 110 may control the memory 120 to form at least one block to be allocated for each different plaintext (e.g., P1 to P3). In addition, when ciphertexts for different plaintexts are stored in different numbers of blocks, the processor 110 may allocate different blocks with the same number as the maximum number of blocks. Referring to FIG. 4, in blocks related to ciphertexts of P1 to P3, when a P1-related block has a greater maximum number than other blocks, the processor 110 may allocate one or two dummy blocks to each of the P2- and P3-related blocks. The dummy block is a block in which ciphertext is not stored, and the processor 110 may fill the dummy block with dummy data. In this case, the processor 110 may form the block information to further include a prefix notifying whether the block is a valid block for storing ciphertext. In this specification, the prefix may be denoted by R, and may be an indicator indicating a block in which ciphertext is stored in order to distinguish the prefix from a dummy value.

Next, in operation S115, the processor 110 may encrypt the block information and generate mapping information for associating the order information of the plaintext with the encrypted block information.

Specifically, as can be seen in FIG. 4, the processor 110 may encrypt the block information including the start position of the block, the maximum value, the number of ciphertexts in the block, and the prefix, using the encryption secret key Ks of the server 100.

Next, the processor 110 may associate the order information with the encrypted block information based on the related plaintext, and generate mapping information with the associated information. For example, as illustrated in FIG. 4, the mapping information may be defined and managed as a block information table. As another example, the mapping information may be defined and managed in the form of a linked list.

Summarizing the foregoing description with reference to Table 1 and FIG. 4, the block information may be generated as, for example, E(Ks, R∥B¹ₚ₁∥N¹ₚ₁∥M¹ₚ₁). Since values of the order information Oₚₓ in the block mapping table are arranged in ascending order in proportion to the value of the plaintext Px, when a range search is requested, the location of the block in which the ciphertext for each plaintext is stored may be effectively inquired. As described above in operation S110, after the prefix R is included in the block information E(Ks, R∥B¹ₚ₁∥N¹ₚ₁∥M¹ₚ₁) and the block information is decrypted, the processor 110 may determine whether the block information is a dummy block based on the presence/absence of R.

As described above, the block in which the ciphertext is already stored may be managed by the mapping information that associates the block information in which the location and size of the ciphertext is encrypted with the order information of the plaintext, and the processor 110 may allocate the block of the ciphertext to be stored later based on the mapping information.

According to the present disclosure, the block in which the ciphertext is stored may be formed at an arbitrary location, and the block information including the start position of the block when mapped with the order information may also be encrypted by the encryption secret key of the server 100, so that the order of the block may not known without the secret key. Accordingly, plaintext information cannot be inferred from the ciphertext stored in the encryption database 120, and a distance and distribution between the plaintexts cannot be inferred from a plurality of ciphertexts. That is, according to the present disclosure, the security of the encryption database may be further strengthened.

Next, in operation S120, the client 200 may receive a plaintext search request that the user wants to search for, and the client agent 210 may check a search range of the plaintext.

Specifically, the client 200 may request the client agent 210 to search for data related to plaintext that satisfies x1<P<x2.

Next, in operation S125, order information corresponding to the search range may be calculated for the client agent, and a query based on the order information may be transmitted to the DB device 100.

Specifically, the client agent 210 may transmit a query based on a range of the order information, that is, Ord(Ko, x1)<C<Ord(Ko, x2) to the DB device 100, based on x1 and x2 and the order information operation secret key Ko.

Next, in operation S130, the processor 110 may access the block associated with the range of the order information using the mapping information, and extract the ciphertext of the accessed block.

Referring to the above operation with the block mapping table of FIG. 4, the processor 110 may access all blocks mapped with the order information greater than Ord(Ko, x1) and smaller than Ord(Ko, x2) by referring to the block mapping table. The processor 110 may extract as many ciphertexts as the number of ciphertexts stored in the table from the accessed blocks and merge the extracted ciphertexts.

Next, in operation S135, the processor 110 may respond with the extracted ciphertext to the client 200, and the client agent 210 may decrypt the ciphertext and provide plaintext within the search range to the client 200.

Specifically, the client agent 210 may decrypt the received ciphertexts through the decryption algorithm D and the encryption secret key Kc, that is, D(Kc, Cp) to obtain plaintext (Px∥i) to which a frequency concealment code is added, and may provide the plaintext Px in which the code is excluded from Px∥i.

According to the present disclosure, the number of decryption operations required to search for a response to a range search may be reduced compared to the related art. Specifically, when the number of plaintexts corresponding to the search range is n, the response may be output through 2n decryption operations and transmitted to the client agent 210. That is, the client agent 210 may respond to the query by performing only decryption operations in a number corresponding to the number of pieces of data received in response.

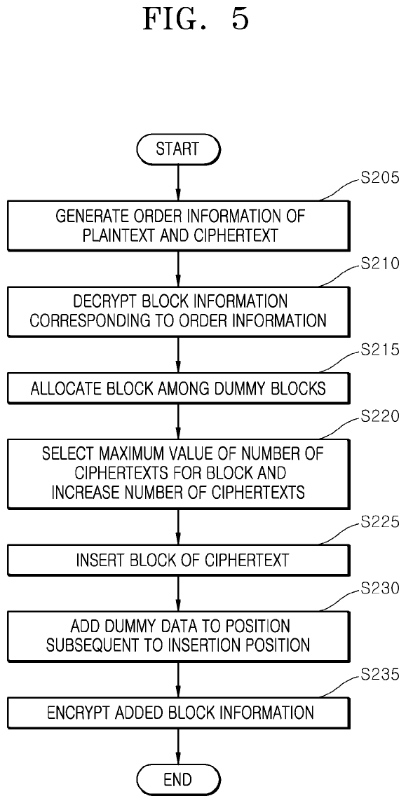

Hereinafter, with reference to FIGS. 5 to 9, embodiments in which the DB device 100 makes an insertion request (or generation request) of ciphertext for the plaintext that the client 200 wants to store, and a deletion request of the ciphertext for the plaintext to be deleted and an update request of the ciphertext will be described.

FIG. 5 is a flowchart illustrating an example of a ciphertext insertion process according to the present disclosure.

First, in operation S205, the client 200 may receive an insertion request for plaintext to be stored in the encryption database 120, and the client agent 210 may calculate order information of the plaintext, generate ciphertext for the plaintext, and transmit the generated ciphertext to the DB device 100.

Specifically, the client agent 210 may calculate the order information for the plaintext Px, that is, Opx=Ord(Ko, Px), using the order information operation secret key Ko. In addition, the client agent 210 may generate Cⁱₚₓ for the plaintext Px using Px, the frequency concealment code, and the encryption secret key Kc. The client agent 210 may transmit the order information Opx and the ciphertext Cⁱₚₓ to the DB device 100.

Next, in operation S210, the processor 110 may decrypt block information of mapping information corresponding to the order information of the insertion request.

Specifically, referring to the block mapping table of FIG. 4, the processor 110 may search for the block information related to the order information Opx and decrypt the block information using the encryption secret key Ks.

Next, in operation S215, when a block having no prefix, that is, a dummy block, is selected based on the decrypted block information, the processor 110 may allocate a start position B^{y}ₚₓ of the selected block to insert the ciphertext.

Next, in operation S220, the processor 110 may select a maximum value of the number of ciphertexts of the allocated block and increase the number of ciphertexts in the block.

Specifically, M^{y}ₚₓ that satisfies (minimum Mₘᵢₙ, maximum Mₘₐₓ) may be selected as the maximum value. When there is no ciphertext allocated to the allocated block, the number of ciphertexts N^{y}ₚₓ may be set to 1.

Next, in operation S225, the processor 110 may insert the ciphertext Cⁱₚₓ at the start position B^{y}ₚₓ of the allocated block.

Next, in operation S230, the processor 110 may add dummy data from a position subsequent to the insertion position of the ciphertext to a position corresponding to the maximum value of the allocated block.

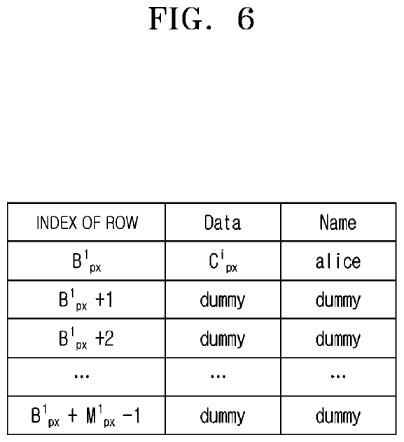

Referring to FIG. 6 illustrating an example of the insertion of ciphertext, dummy data may be added from B^{y}ₚₓ+1, which is a position subsequent to the insertion position, to B^{y}ₚₓ+M^{y}ₚₓ−1, which is a position corresponding to the maximum value. Accordingly, the number of ciphertexts inserted into the block B^{y}ₚₓ may not be exposed.

Next, in operation S235, the processor 110 may encrypt the block information of the block in which the ciphertext and the dummy data are stored to update the mapping information.

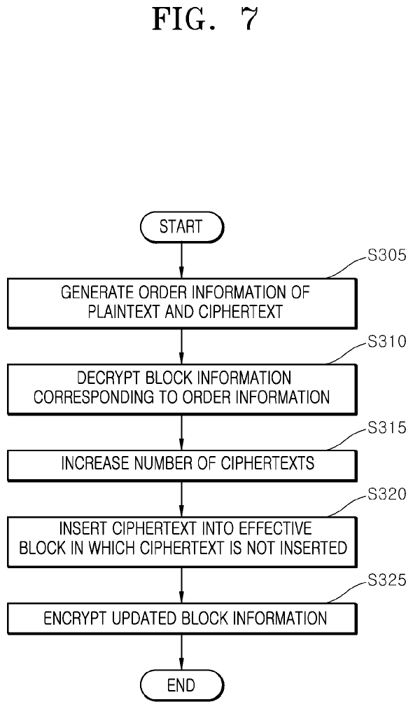

FIG. 7 is a flowchart illustrating another example of a ciphertext insertion process according to the present disclosure.

First, in operation S305, the client 200 may receive an insertion request for plaintext to be stored in the encryption database 120, and the client agent 210 may calculate order information of the plaintext, generate ciphertext for the plaintext, and transmit the generated ciphertext to the DB device 100.

Next, in operation S310, the processor 110 may decrypt the block information of the mapping information corresponding to the order information of the insertion request. Operations S305 and S310 are substantially the same as those described in FIG. 5.

Next, in operation 315, when a block in which a prefix is present, that is, a valid block, is selected based on the decrypted block information, the processor 110 may allocate the selected block to insert the ciphertext and may increase the number of ciphertexts in the allocated block.

Specifically, the current ciphertext number N^{y}ₚₓ may be checked from the block information of the allocated block, and the processor 110 may increase the checked number to N^{y}ₚₓ+1 by the inserted ciphertext.

Next, in operation S320, the processor 110 may store the ciphertext in a location where ciphertext is not inserted in the allocated effective block.

Specifically, the storage location of the ciphertext may be an address of the memory 120 corresponding to a location shifted by the current number of ciphertexts from the start position of the block, that is, B^{y}ₚₓ+N^{y}ₚₓ.

Next, in operation S325, the processor 110 may encrypt block information of a block in which a new ciphertext is stored to update the mapping information.

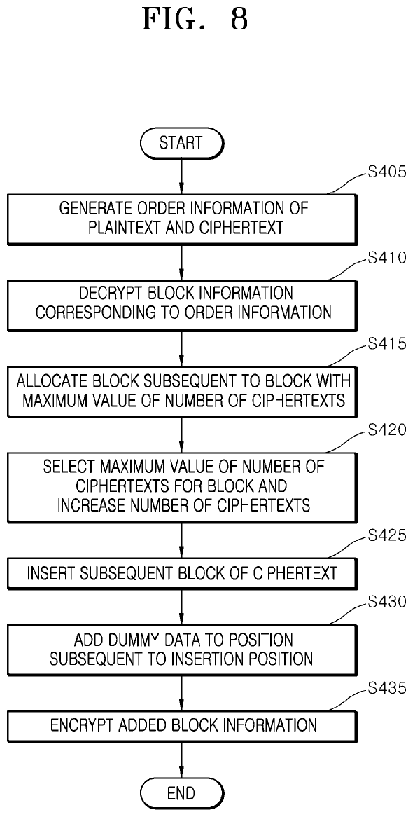

FIG. 8 is a flowchart illustrating another example of a ciphertext insertion process according to the present disclosure.

First, in operation S405, the client 200 may receive an insertion request for plaintext to be stored in the encryption database 120, and the client agent 210 may calculate order information of the plaintext, generate ciphertext for the plaintext, and transmit the generated ciphertext to the DB device 100.

Next, in operation S410, the processor 110 may decrypt block information of mapping information corresponding to the order information of the insertion request. Operations S405 and S410 are substantially the same as those described in FIG. 5.

Next, in operation S415, when it is determined based on the decrypted block information that a block in which the prefix is present stores the ciphertext with the maximum value, the processor 110 may allocate a block subsequent to the block with the maximum value to insert the ciphertext.

Taking an example of an index of a row associated with specific order information in the block mapping table of FIG. 4, the start position of the subsequent block to be allocated may be B^{y+1}ₚₓ.

Next, similar to operation S220, in operation S420, the processor 110 may select a maximum value M^{y+1}ₚₓ of the number of ciphertexts in the allocated block, and increase the number of ciphertexts N^{y+1}ₚₓ in the block. When there is no ciphertext allocated to the allocated block, the number of ciphertexts N^{y}ₚₓ may be set to 1.

Next, similar to operation S225, the processor 110 may insert the ciphertext Cⁱₚₓ at the start position B^{y+1}ₚₓ of the allocated block in operation S425.

Next, in operation S430, the processor 110 may add dummy data from a position subsequent to the insertion position of the ciphertext to a position corresponding to the maximum value of the allocated block.

Similar to operation S230, the dummy data may be added from B^{y+1}ₚₓ+1, which is the position subsequent to the insertion position, to B^{y+1}ₚₓ+M^{y}ₚₓ−1, which is the position corresponding to the maximum value. Accordingly, the number of ciphertexts inserted into the block B^{y}ₚₓ may not be exposed.

Next, in operation S435, the processor 110 may encrypt block information of a block in which the ciphertext and the dummy data are stored to update the mapping information.

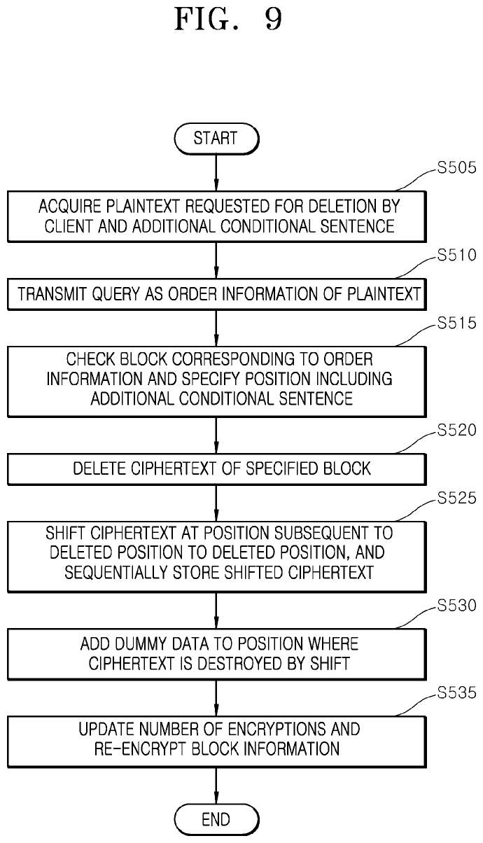

FIG. 9 is a flowchart illustrating a ciphertext deletion process according to the present disclosure.

First, in operation S505, the client 200 may receive a plaintext deletion request from the encryption database 120 and obtain an additional conditional sentence.

Specifically, when the client 200 deletes specific rows stored in the encryption database 120, the additional conditional statement may be provided along with the plaintext Px. The present embodiment will be described as an example of deleting a row satisfying a condition P=Px AND name=‘alice.’

Next, in operation S510, the client agent 210 may calculate order information of a plaintext requested for deletion using the order information operation secret key Ko, and transmit a query and the additional conditional sentence based on the order information to the DB device 100.

Referring to the above example, the client agent 210 may transmit the query by replacing Px with Oₚₓ.

Next, in operation S515, the processor 110 may decrypt the block information of the mapping information corresponding to the order information to identify the block, and may specify the location of the block including the additional conditional statement.

Referring to the above example, the processor 110 may search for the locations of blocks in which the ciphertext of the plaintext Px is stored through the block mapping table of FIG. 4, and find an i^{th} row satisfying name=‘alice.’

Next, in operation S520, the processor 110 may be executed to delete the plaintext at the location of the specified block in the encryption database 120.

Next, in operation S525, the processor 110 may shift the ciphertext at a position subsequent to the deleted position to the deleted position and sequentially store the shifted ciphertext.

In the above example, the ciphertext may be shifted from B^{y}ₚₓ+i, that is, a position where ciphertexts located from B^{y}ₚₓ+i+1 to B^{y}ₚₓ+M^{y}ₚₓ−1 are deleted, which is a series of positions subsequent to the deleted position, to B^{y}ₚₓ+M^{y}ₚₓ?? 2 that is a position proceeding a position where the ciphertext is scheduled to be deleted, and stored.

Next, in operation S530, the processor 110 may add dummy data to the position where the ciphertext is destroyed by the shift.

Referring to the above example, the dummy data may be added to B^{y}ₚₓ+M^{y}ₚₓ−1, which is the position where the ciphertext is destroyed.

Next, in operation S535, the processor 110 may re-encrypt the block information and update the mapping information to update the number of ciphertexts of the block on which the deletion process has been executed.

Referring to the above example, in order to reflect the reduced number of ciphertexts in the block, the number of ciphertexts N^{y}ₚₓ may be updated by the number of deleted block information.

The process of updating the ciphertext may proceed similarly to the process of deleting the ciphertext of FIG. 9 except for operations S520 to S535.

Referring to the update process, the DB device 100 may receive a plaintext update request from the client 200. The update request may include an alternative conditional statement related to order information of alternative plaintext and plaintext to be updated. The processor 110 may check the block using block information of mapping information corresponding to order information included in the update request. Next, the processor 110 may specify the position of the alternative conditional sentence in the checked block, and may update ciphertext that is present to the ciphertext related to the alternative conditional sentence at the position of the specified block. The processor 110 may update the mapping information after re-encrypting the block information to maintain the number of ciphertexts of the specified block.

According to the embodiments according to FIGS. 5 to 9, it is possible to implement the conventional method of updating ciphertext having a large amount of ciphertext change processing such as insertion, deleting, and updating in a simpler manner.

Exemplary methods of this disclosure are presented as a series of operations for clarity of explanation, but this is not intended to limit the order in which steps are performed, and each step may be performed concurrently or in a different order, as necessary. In order to implement the method according to the present disclosure, other steps may be included in addition to the exemplified steps, other steps may be included except for some steps, or additional other steps may be included except for some steps.

Various embodiments of the present disclosure are intended to explain representative aspects of the present disclosure rather than listing all possible combinations, and details described in various embodiments may be applied independently or in combination of two or more.

In addition, various embodiments of the present disclosure may be implemented by hardware, firmware, software, or a combination thereof. For implementation by hardware may be performed by one or more application specific integrated circuits (ASICs), digital signal processors (DSPs), digital signal processing devices (DSPDs), programmable logic devices (PLDs), field programmable gate arrays (FPGAs), a general processor, a controller, a microprocessor, and the like.

The scope of the present disclosure includes software or machine-executable instructions (e.g., operating system, applications, firmware, programs, etc.) that cause operations according to the method according to various embodiments to be executed on a device or computer, and a non-transitory computer-readable medium in which such software or instructions are stored and executable on the device or computer.

What is claimed is:

1. An encryption database device comprising:
a memory configured to store and read information; and
a processor configured to control the storing and reading of the memory,
wherein the processor is configured to:
allocate blocks to the memory and store at least one ciphertext for plaintext for each of the blocks;
generate mapping information associating order information of the plaintext with block information obtained by encrypting a start position of the block in which the ciphertext is stored;
access the block associated with the order information corresponding to a search range of the plaintext requested by a client using the mapping information; and
respond with information related to the ciphertext of the accessed block to the client.

2. The encryption database device of claim 1, wherein the order information is configured according to the order of the size of the plaintext.

3. The encryption database device of claim 1, wherein, when the plaintext is present as a plurality of pieces of identical information, the ciphertext is encrypted by padding a frequency concealment code for each plaintext, and the frequency concealment code includes a different random number or counter information for each plaintext.

4. The encryption database device of claim 1, wherein the block stores the ciphertext in a number corresponding to a maximum value, and the block information is generated by encrypting the start position, the maximum value, and the number of ciphertexts stored in the block.

5. The encryption database device of claim 4, wherein, when the block is generated as a plurality of blocks and ciphertexts for different plaintexts are stored as different numbers of blocks, the processor is configured to:
allocate different blocks in a number corresponding to the maximum number of blocks;
fill a block in which the ciphertext is not stored with dummy data; and
form the block information to further include a prefix notifying whether the block is a valid block for storing the ciphertext.

6. The encryption database device of claim 5, wherein the processor is further configured to:
receive an insertion request of the ciphertext transmitted from the client;
decrypt the block information of the mapping information corresponding to the order information included in the insertion request;
allocate, when a block in which the prefix is not present is selected based on the decrypted block information, the ciphertext to the selected block;
insert the ciphertext into the allocated block while increasing the number of ciphertexts of the allocated block;
add dummy data from a position subsequent to the insertion position of the ciphertext to a position corresponding to a maximum value of the allocated block; and
update the mapping information after encrypting the block information of the allocated block.

7. The encryption database device of claim 5, wherein the processor is further configured to:
receive an insertion request of the ciphertext transmitted from the client;
decrypt the block information of the mapping information corresponding to the order information included in the insertion request;
allocate, when a block in which the prefix is present is selected based on the decrypted block information, the ciphertext to the selected block;
insert the ciphertext into the allocated block while increasing the number of ciphertexts of the allocated block; and
update the mapping information after encrypting the block information of the allocated block.

8. The encryption database device of claim 5, wherein the processor is further configured to:
receive an insertion request of the ciphertext transmitted from the client;
decrypt the block information of the mapping information corresponding to the order information included in the insertion request;
allocate, when it is determined based on the decrypted block information that a block in which the prefix is present stores the ciphertext with the maximum value, the ciphertext to a block subsequent to the block having the maximum value;
insert the ciphertext into the allocated block while increasing the number of ciphertexts of the allocated block;
add dummy data from a position subsequent to the insertion position of the ciphertext to a position corresponding to the maximum value of the allocated block; and
update the mapping information after encrypting the block information of the allocated block.

9. The encryption database device of claim 4, wherein the processor is further configured to:
receive a plaintext deletion request from the client;
check the block using the block information of the mapping information corresponding to the order information included in the deletion request;
specify a position of an additional conditional sentence related to the plaintext in the checked block;
delete ciphertext related to the additional conditional sentence from the specified block;
shift the ciphertext at a position subsequent to the deleted position to the deleted position and sequentially store the shifted ciphertext;
add dummy data to a position where the ciphertext is destroyed by the shift; and
update the mapping information after re-encrypting the block information to update the number of ciphertexts of the specified block.

10. The encryption database device of claim 4, wherein the processor is further configured to:
receive an update request of the plaintext from the client;
check the block using the block information of the mapping information corresponding to the order information included in the update request;
specify a position of an alternative conditional statement related to the plaintext in the checked block;
update ciphertext present in the specified block with ciphertext related to the alternative conditional sentence; and
update the mapping information after re-encrypting the block information to maintain the number of ciphertexts of the specified block.

11. A method of constructing an encryption database using an encryption database device, the method comprising:
allocating blocks and storing at least one ciphertext for plaintext for each of the blocks;
generating mapping information associating order information of the plaintext with block information obtained by encrypting a start position of the block in which the ciphertext is stored;
accessing the block associated with the order information corresponding to a search range of the plaintext requested by a client using the mapping information; and
responding with information related to the ciphertext of the accessed block to the client.

12. The method of claim 11, wherein the order information is configured according to the order of the size of the plaintext.

13. The method of claim 11, wherein, when the plaintext is present as a plurality of pieces of identical information, the ciphertext is encrypted by padding a frequency concealment code for each plaintext, and the frequency concealment code includes a different random number or counter information for each plaintext.

14. The method of claim 11, wherein the block stores the ciphertext in a number corresponding to a maximum value, and the block information is generated by encrypting the start position, the maximum value, and the number of ciphertexts stored in the block.

15. The method of claim 14, wherein the block is generated as a plurality of blocks, and the generating of the mapping information includes:
allocating different blocks in a number corresponding to the maximum number of blocks when ciphertexts for different plaintexts are stored as different numbers of blocks;
filling a block in which the ciphertext is not stored with dummy data; and
forming the block information to further include a prefix notifying whether the block is a valid block for storing the ciphertext.

16. The method of claim 15, further comprising, after the generating of the mapping information:
receiving an insertion request of the ciphertext transmitted from the client;
decrypting the block information of the mapping information corresponding to the order information included in the insertion request;
allocating, when a block in which the prefix is not present is selected based on the decrypted block information, the ciphertext to the selected block;
inserting the ciphertext into the allocated block while increasing the number of ciphertexts of the allocated block;
adding dummy data from a position subsequent to the insertion position of the ciphertext to a position corresponding to a maximum value of the allocated block; and
updating the mapping information after encrypting the block information of the allocated block.

17. The method of claim 15, further comprising, after the generating of the mapping information:
receiving an insertion request of the ciphertext transmitted from the client;
decrypting the block information of the mapping information corresponding to the order information included in the insertion request;
allocating, when a block in which the prefix is present is selected based on the decrypted block information, the ciphertext to the selected block;
inserting the ciphertext into the allocated block while increasing the number of ciphertexts of the allocated block; and
updating the mapping information after encrypting the block information of the allocated block.

18. The method of claim 15, further comprising, after the generating of the mapping information:
receiving an insertion request of the ciphertext transmitted from the client;
decrypting the block information of the mapping information corresponding to the order information included in the insertion request;
allocating, when it is determined based on the decrypted block information that a block in which the prefix is present stores the ciphertext with the maximum value, the ciphertext to a block subsequent to the block having the maximum value;
inserting the ciphertext into the allocated block while increasing the number of ciphertexts of the allocated block;
adding dummy data from a position subsequent to the insertion position of the ciphertext to a position corresponding to the maximum value of the allocated block; and
updating the mapping information after encrypting the block information of the allocated block.

19. The method of claim 14, further comprising, after the generating of the mapping information:
receiving a plaintext deletion request received from the client;
checking the block using the block information of the mapping information corresponding to the order information included in the deletion request;
specifying a position of an additional conditional sentence related to the plaintext in the checked block;
deleting ciphertext related to the additional conditional sentence from the specified block;
shifting the ciphertext at a position subsequent to the deleted position to the deleted position and sequentially storing the shifted ciphertext;
adding dummy data to a position where the ciphertext is destroyed by the shift; and
updating the mapping information after re-encrypting the block information to update the number of ciphertexts of the specified block.

20. An encryption database system comprising:
an encryption database device including a memory configured to store and read information and a processor configured to control the storing and reading of the memory; and
a client including a client agent configured to encrypt and decrypt information exchanged with the device,
wherein the processor is configured to allocate blocks to the memory and store at least one ciphertext for plaintext for each of the blocks, and generate mapping information associating order information of the plaintext with block information obtained by encrypting a start position of the block in which the ciphertext is stored,
the client agent calculates the order information corresponding to a plaintext search range requested by the client, and transmits a query based on the order information to the device,
the processor accesses the block associated with the order information corresponding to the plaintext search range requested by the client using the mapping information, extracts the ciphertext of the accessed block, and responds with the extracted ciphertext to the client agent, and
the client agent decrypts the responded ciphertext and provides the plaintext of the search range to the client.
